(19) United States
(12) Patent Application Publication
(10) Pub. No.: US 2013/0030796 A1
(43) Pub. Date: Jan. 31, 2013

(54) AUDIO ENCODING APPARATUS AND AUDIO ENCODING METHOD

(71) Applicant: Zongxian Liu, Singapore (SG)

(72) Inventor: Zongxian Liu, Singapore (SG)

(73) Assignee: PANASONIC CORPORATION, Kadoma-shi (JP)

(21) Appl. No.: 13/521,590

(22) PCT Filed: Jan. 13, 2011
(86) PCT No.: PCT/JP2011/000134

§ 371 Date: Jul. 11, 2012

(30) Foreign Application Priority Data
Jan. 14, 2010 (JP) 2010-006312

(51) Int. Cl. G10L 21/00

(52) U.S. Cl. 704/205; 704/E21.001

(57) ABSTRACT

An audio encoding apparatus that allows a decoded signal exhibiting an excellent sound quality to be obtained on a decoding side. In the audio encoding apparatus (1000A), a time-frequency transform unit (1001) uses a time-frequency transform, such as a discrete Fourier transform (DFT) or a modified discrete cosine transform (MDCT), to transform a time domain signal (S(n)) to a frequency domain signal (spectrum factor) (S(f)). A psychoacoustic model analyzing unit (1002) performs a psychoacoustic model analysis of the frequency domain signal (S(f)), thereby obtaining a masking curve. An acoustic sense weighting unit (1003) estimates, based on the masking curve, an importance degree of acoustic sense, and determines and applies the weighting factors of respective spectrum factors to the respective spectrum factors. An encoding unit (1004) encodes the frequency domain signal (S(f)) as weighted in terms of the acoustic sense. A multiplexing unit (1005) multiplexes and transmits the encoded parameters.

### TECHNICAL FIELD

The present invention relates to an encoding speech apparatus and an encoding speech method.

### BACKGROUND ART

Speech coding techniques are categorized into mainly two coding techniques, i.e., transform coding and linear predictive coding.

The transform coding transforms signals from a time domain into a spectral domain and then encodes spectral coefficients using a discrete Fourier transform (DFT) or a modified discrete cosine transform (MDCT), for example. The coding process generally involves calculating perceptual importance levels of the spectral coefficients using a psychoacoustic model and then encoding the spectral coefficients according to each perceptual importance level. Some common transform coding techniques include MPEG MP3, MPEG AAC, and Dolby AC3. The transform coding is effective for music signals and general speech signals.

FIG. 1 illustrates a configuration of the transform coding.

In the coding side of FIG. 1, time-frequency transforming section 101 transforms time domain signal S(n) into frequency domain signal S(f) using time-frequency transformation such as discrete Fourier transform (DFT) or modified discrete cosine transform (MDCT).

Psychoacoustic model analyzing section 103 performs a psychoacoustic model analysis on frequency domain signal S(f) to calculate a masking curve.

According to the masking curve calculated by the psychoacoustic model analysis, coding section 102 encodes frequency domain signal S(f) not to create quantization noise.

Multiplexing section 104 multiplexes the coding parameter generated at coding section 102 with the signal to generate bit stream information, and transmits the bit stream information to a decoding side.

In the decoding side of FIG. 1, demultiplexing section 105 demultiplexes the bit stream information to generate the coding parameter.

Decoding section 106 decodes the coding parameter to generate decoded frequency domain signal S^{˜}(f).

By using frequency-time transformation such as inverse discrete Fourier transform (IDFT) or inverse modified discrete cosine transform (IMDCT), frequency-time transforming section 107 transforms decoded frequency domain signal S^{˜}(f) into a time domain, to generate decoded time domain signal S^{˜}(n).

On the other hand, the linear predictive coding obtains a residual/excitation signal by using redundancy of a speech signal in a time domain and applying linear prediction to an input speech signal. In the case of a speech signal, especially an active speech section (with resonance effect and a component of a pitch period with high amplitude), the linear predictive coding efficiently generates an audio playback signal. After the linear prediction, main two different techniques such as TCX and CELP encode the residual/excitation signal.

TCX efficiently transforms and encodes the residual/excitation signal in a frequency domain. Some common TCX coding techniques include 3GPP AMR-WB+, MPEG USAC, for example.

FIG. 2 illustrates a configuration of the TCX coding.

In the coding side of FIG. 2, LPC analyzing section 201 performs LPC analysis on an input signal to use redundancy of a signal in a time domain.

Coding section 202 encodes the LPC coefficients from LPC analyzing section 201.

Decoding section 203 decodes the encoded LPC coefficients.

Inverse filter section 204 applies an LPC inverse filter to input signal S(n), using the decoded LPC coefficients from decoding section 203, to obtain residual (excitation) signal Sᵣ(n).

Time-frequency transforming section 205 transforms residual signal Sᵣ(n) into frequency domain signal Sᵣ(f) using time-frequency transformation such as discrete Fourier transform (DFT) or modified discrete cosine transform (MDCT).

Coding section 206 encodes Sᵣ(f).

Multiplexing section 207 multiplexes the LPC coefficients generated and encoded at coding section 202 and the coding parameter generated at coding section 206 to generate bit stream information, and transmits the bit stream information to the decoding side.

In the decoding side of FIG. 2, demultiplexing section 208 demultiplexes the bit stream information to generate the encoded LPC coefficients and coding parameter.

Decoding section 210 decodes the coding parameter to generate decoded residual signal Sᵣ^{˜}(f) of a frequency domain.

LPC coefficient decoding section 209 decodes the encoded LPC coefficients to obtain LPC coefficients.

By using frequency-time transformation such as inverse discrete Fourier transform (IDFT) or inverse modified discrete cosine transform (IMDCT), frequency-time transforming section 211 transforms decoded residual signal Sᵣ^{˜}(f) of a frequency domain into a time domain, to generate decoded residual signal Sᵣ^{˜}(n) of the time domain.

Synthesis filter 212 performs LPC synthesis filtering processing on decoded residual signal Sᵣ^{˜}(n) of the time domain using the LPC coefficients decoded at LPC coefficient decoding section 209, to obtain decoded time domain signal S^{˜}(n).

Also, CELP coding encodes a residual/excitation signal using a predetermined code book. In order to improve the sound quality, the

CELP coding transforms an error signal into a frequency domain for coding, the error signal between the original signal and an LPC synthesized signal. Common CELP coding techniques include ITU-T G.729.1, ITU-T G.718, for example.

FIG. 3 illustrates a configuration of coding combining the CELP coding and the transform coding.

In the coding side of FIG. 3, CELP coding section 301 performs the CELP coding on an input signal to use redundancy of a signal in a time domain.

CELP decoding section 302 generates synthesized signal S_{syn}(n) using a CELP parameter generated at CELP coding section 301.

By subtracting the synthesized signal from the input signal, subtractor 310 obtains error signal Sₑ(n) (error signal between the input signal and the synthesized signal).

Time-frequency transforming section 303 transforms error signal Sₑ(n) into frequency domain signal Sₑ(f) (spectral coefficients) using time-frequency transformation such as discrete Fourier transform (DFT) or modified discrete cosine transform (MDCT).

Coding section 304 encodes Sₑ(f).

Multiplexing section 305 multiplexes the CELP parameter generated at CELP coding section 301 and the coding parameter generated at coding section 304 to generate bit stream information, and transmits the bit stream information to the decoding side.

In the decoding side of FIG. 3, demultiplexing section 306 demultiplexes the bit stream information to generate the CELP parameter and the coding parameter.

Decoding section 308 decodes the coding parameter to generate decoded residual signal Sₑ^{˜}(f) of a frequency domain.

CELP decoding section 307 generates CELP synthesized signal S_{syn}(n) using the CELP parameter.

Frequency-time transforming section 309 transforms decoded residual signal Sₑ^{˜}(f) of a frequency domain into a time domain using frequency-time transformation such as inverse discrete Fourier transform (IDFT) or inverse modified discrete cosine transform (IMDCT), to generate decoded residual signal (predictive error signal) Sₑ^{˜}(n) of the time domain.

Adder 311 generates decoded time domain signal S^{˜}(n) by adding CELP synthesized signal S_{syn}(n) and decoded predictive error signal Sₑ^{˜}(n).

Transform coding and linear predictive coding apply a certain coding technique to a signal of a frequency domain, that is, spectral coefficients (transform coefficients).

In order to concentrate limited coding bits to perceptually-important spectral coefficients, generally before encoding, coding of spectral coefficients by transform coding calculates weighting coefficients representing the perceptual importance level of the spectral coefficients, to use for encoding the spectral coefficients.

The transform coding generally calculates perceptually-weighting coefficients according to a psychoacoustic model to use masking phenomenon which is specific to human hearing mechanism.

Meanwhile, since the linear predictive coding performs linear prediction on an input signal, it is not easy to obtain a psychoacoustic model. Thus, the perceptually-weighting coefficients are generally calculated based on an energy-to-noise ratio or a signal-to-noise ratio.

Hereinafter, the coding of the spectral coefficients applied to the transform coding or the linear predictive coding is referred to as “pulse vector coding.”

In the fifth layer in ITU-T G.718 which is newly-standardized speech coding, factorial pulse coding which is one of pulse vector coding technique has been proposed (FIG. 4 ).

The factorial pulse coding is pulse vector coding in which coding information is a unit magnitude pulse. In the pulse vector coding, the spectral coefficients which are coding targets are represented by a plurality of pulses, and the positions, amplitudes, and polarities of these pulses are calculated, to encode this information. In this case, in order to normalize a pulse by unit amplitude, a global gain is also calculated for coding. As illustrated in FIG. 5, the coding parameter of the pulse vector coding includes a global gain, a pulse position, a pulse amplitude, and a pulse polarity.

FIG. 6 shows a concept of the pulse vector coding.

As illustrated in FIG. 6, in input spectrum S(f) having a length equal to N, one global gain and the positions, amplitudes, and polarities of M pulses, are encoded together. In spectrum S^{˜}(f) generated by encoding, only M pulses and their positions, amplitudes, and polarities are generated and all the other spectral coefficients are set as zero.

Conventional transform coding calculates the perceptual importance level based on a subband. One example is TDAC (Time Domain Aliasing Cancellation) coding in G.729.1.

FIG. 7 illustrates a configuration of the TDAC coding in G.729.1.

In FIG. 7, band splitting section 701 splits input signal S(f) (spectral coefficients) into a plurality of subbands. Here, the low band section of the input signal is formed by error-signal MDCT coefficients between the original signal and a CELP decoded signal, and the high band section of the input signal is formed by MDCT coefficients of the original signal.

Spectrum envelope calculating section 702 calculates a spectrum envelope (energy of each subband) for each subband signal {S_{sb}(f)}.

Coding section 703 encodes the spectrum envelope.

Bit allocating section 704 calculates the order of perceptual importance levels {ip_{sb}} according to the encoded spectrum envelopes, to allocate bits to subbands.

Vector quantizing section 705 uses the allocated bits and split spherical VQ method to encode subband signal {S_{sb}(f)}.

### CITATION LIST

### Non-Patent Literature

NPL 1
ITU-T Recommendation G.729.1 (2007) “G.729-based embedded variable bit-rate coder: An 8-32 kbit/s scalable wideband coder bit stream interoperable with G.729”
NPL 2
T. Vaillancourt et al “ITU-T EV-VBR: A Robust 8-32 kbit/s Scalable Coder for Error Prone Telecommunication Channels,” in Proc. Eusipco, Lausanne, Switzerland, August 2008
NPL 3
Lefebvre, et al., “High quality coding of wideband audio signals using transform coded excitation (TCX),” IEEE International Conference on Acoustics, Speech, and Signal Processing, vol. 1, pp. 1/193-1/196, April 1994
NPL 4
Karl Heinz Brandenburg, “MP3 and AAC Explained,” AES 17^{th} International Conference, Florence, Italy, September 1999.

### SUMMARY OF INVENTION

### Technical Problem

Here, it is not effective to calculate the perceptual importance level on a subband basis in a specific coding method such as the above mentioned pulse vector coding.

Calculating the perceptual importance level on a subband basis means that the all perceptual importance levels of the spectral coefficients included in each of the subbands are the same.

Meanwhile, from spectra of all bandwidth, pulse vector coding selects spectral coefficients to be encoded, based on amplitude values of spectral coefficients. In this case, the perceptual importance level calculated on a subband basis cannot accurately represent the perceptual importance level of spectral coefficients.

Let us consider a case where a certain subband includes five spectral coefficients S_{sb}(f0), S_{sb}(f1), S_{sb}(f2), S_{sb}(f3), and S_{sb}(f4) as illustrated in FIG. 8. Also, pulse vector coding is adopted as a coding method in this case. Assuming that S_{sb}(f1) has the largest amplitude among the five spectral coefficients and coding bits allocated to this subband can encode only one pulse in this case, the pulse vector coding selects and encodes S_{sb}(f1). Here, even if the perceptual importance levels are calculated in this subband, S_{sb}(f1) is still encoded. This is because all the perceptual importance levels of five spectral coefficients are the same. However, calculating masking curve M(f) of the original signal shows that S_{sb}(f3) exceeds masking curve M(f), and hence it is understood that S_{sb}(f3) is the most perceptually-important spectral coefficient. Thus, when calculating the perceptual importance levels on a subband basis, a different spectral coefficient (in this example, S_{sb}(f1)) with the largest amplitude value, is encoded, instead of encoding the most perceptually-important spectral coefficient (in this example, S_{sb}(f3)).

Here, although there is a conventional technique determining the masking curve on a frequency basis, the technique performs the distribution of coding bits and perceptual weighting processing on a subband basis. That is, the differences among the perceptual importance levels of spectral coefficients included in a subband are not taken into consideration.

### Solution to Problem

The speech coding apparatus of the present invention employs a configuration having: an estimation section that estimates respective perceptual importance levels of a plurality of spectral coefficients of different frequencies; a calculating section that calculates respective weighting coefficients of a plurality of spectral coefficients based on the respective estimated perceptual importance levels; a weighting section that weights each of a plurality of spectral coefficients using the respective calculated weighting coefficients; and a coding section that encodes a plurality of weighted spectral coefficients.

Also, the speech coding apparatus the present invention that performs layer coding including at least two layers of a lower layer and a higher layer, employs a configuration having: a generating section that generates an error signal between a decoded signal of the lower layer and an input signal; an estimation section that calculates a signal-to-noise ratio using the input signal and the error signal and estimates respective perceptual importance levels of a plurality of spectral coefficients of different frequencies in the error signal, based on the signal-to-noise ratio; a calculating section that calculates respective weighting coefficients of a plurality of spectral coefficients based on the respective estimated importance levels; a weighting section that weights each of a plurality of spectral coefficients using the respective calculated weighting coefficients; and a coding section that encodes a plurality of weighted spectral coefficients.

The speech coding method of the present invention having the steps of: estimating respective perceptual importance levels of a plurality of spectral coefficients of different frequencies; calculating respective weighting coefficients of the plurality of spectral coefficients based on the respective estimated perceptual importance levels; weighting each of the plurality of spectral coefficients using the respective calculated weighting coefficients; and encoding the plurality of weighted spectral coefficients.

### Advantageous Effects of Invention

According to the present invention, the decoding side can obtain a decoded signal with good sound quality.

### BRIEF DESCRIPTION OF DRAWINGS

FIG. 1 illustrates a configuration of transform coding (conventional);

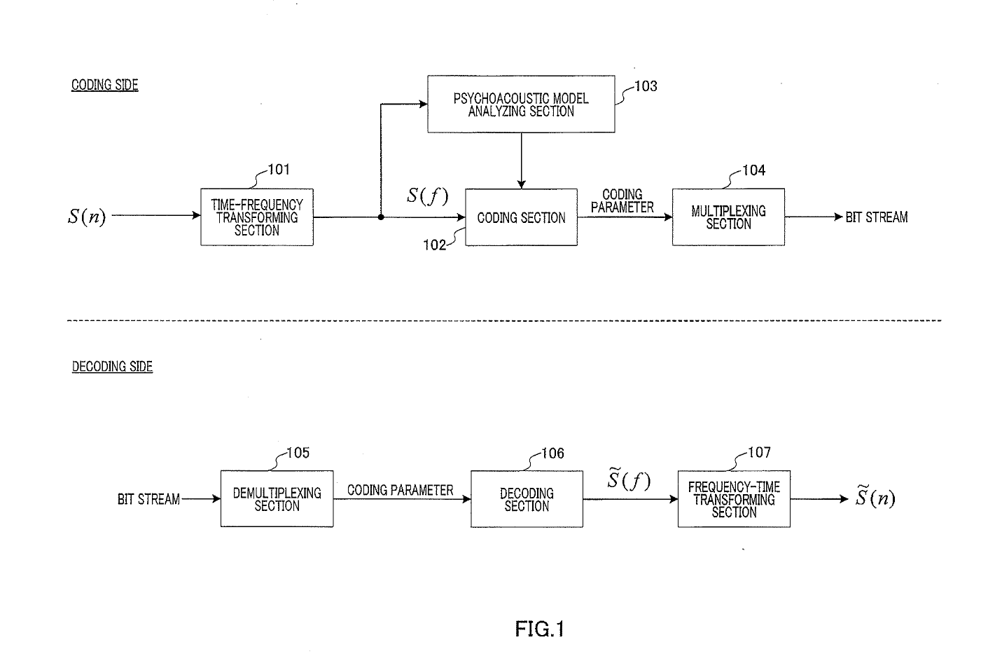

FIG. 2 illustrates a configuration of TCX coding (conventional);

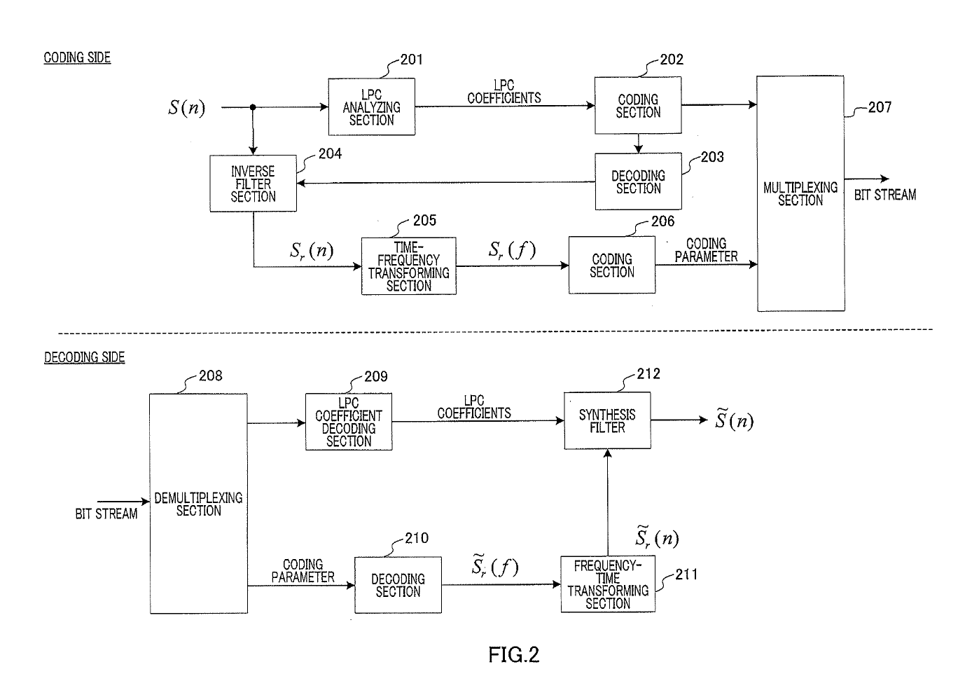

FIG. 3 illustrates a configuration of coding combining CELP coding and transform coding (conventional);

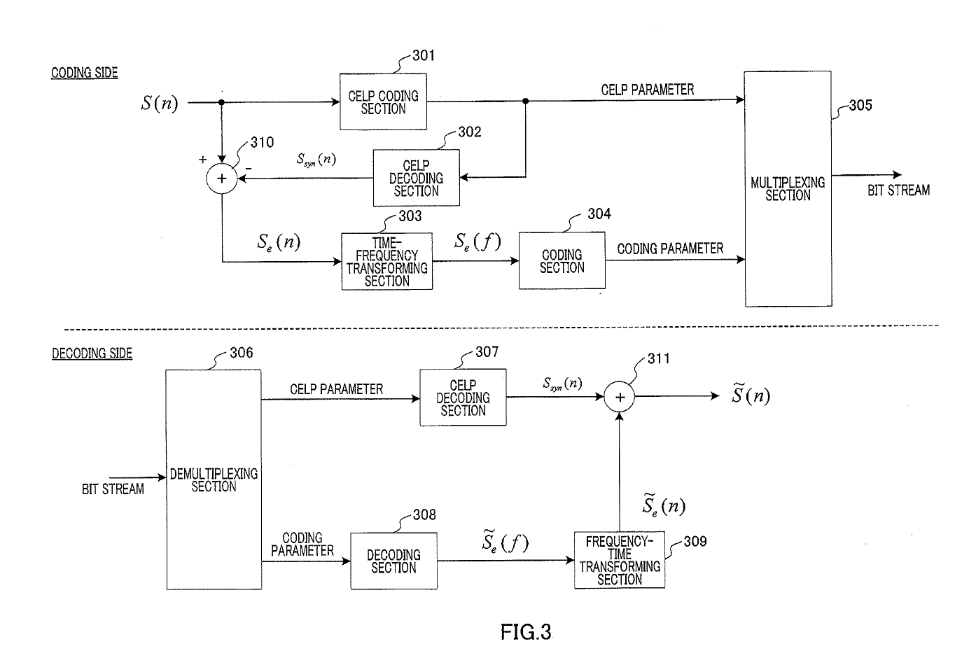

FIG. 4 illustrates a configuration of factorial pulse coding of

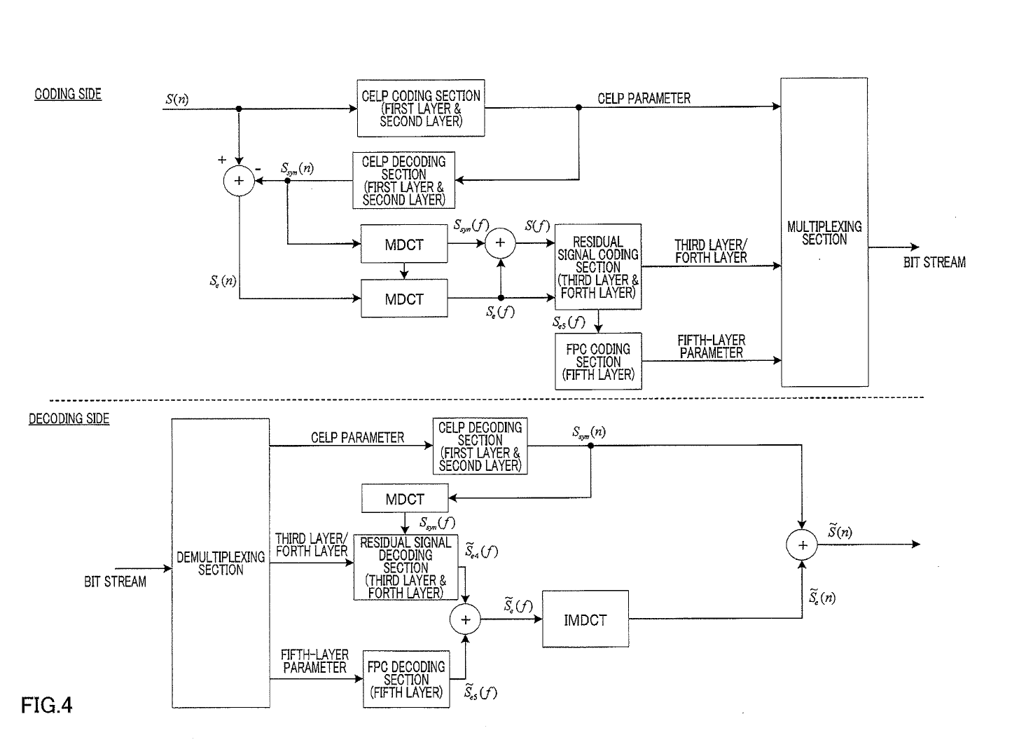

ITU-T G.718 (conventional);

FIG. 5 illustrates a coding parameter of pulse vector coding (conventional);

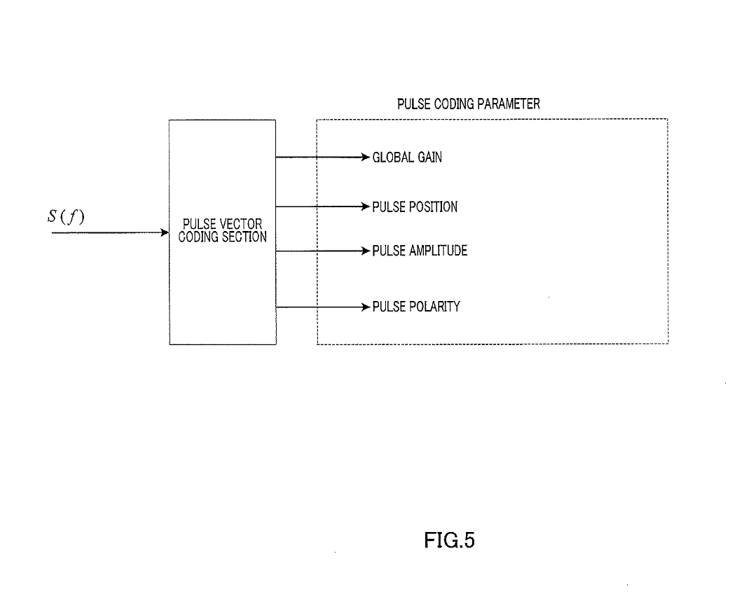

FIG. 6 illustrates a concept of the pulse vector coding (conventional);

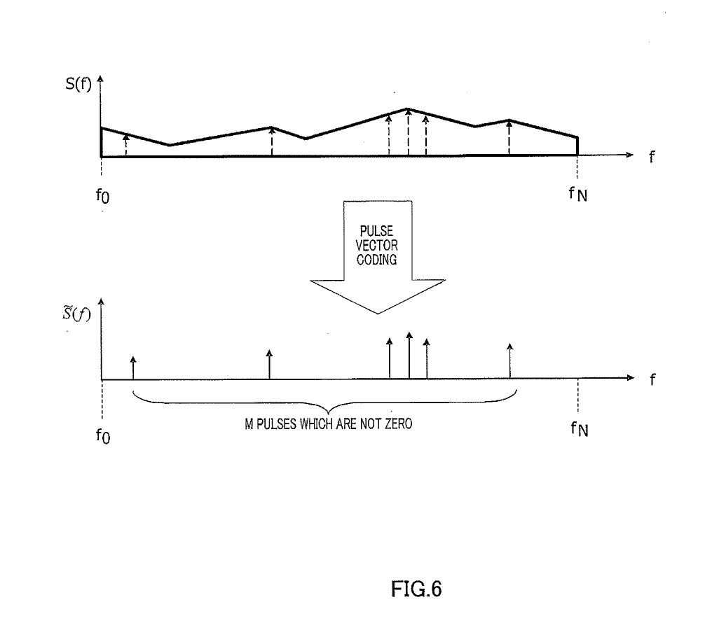

FIG. 7 illustrates a configuration of TDAC coding in G.729.1 (conventional);

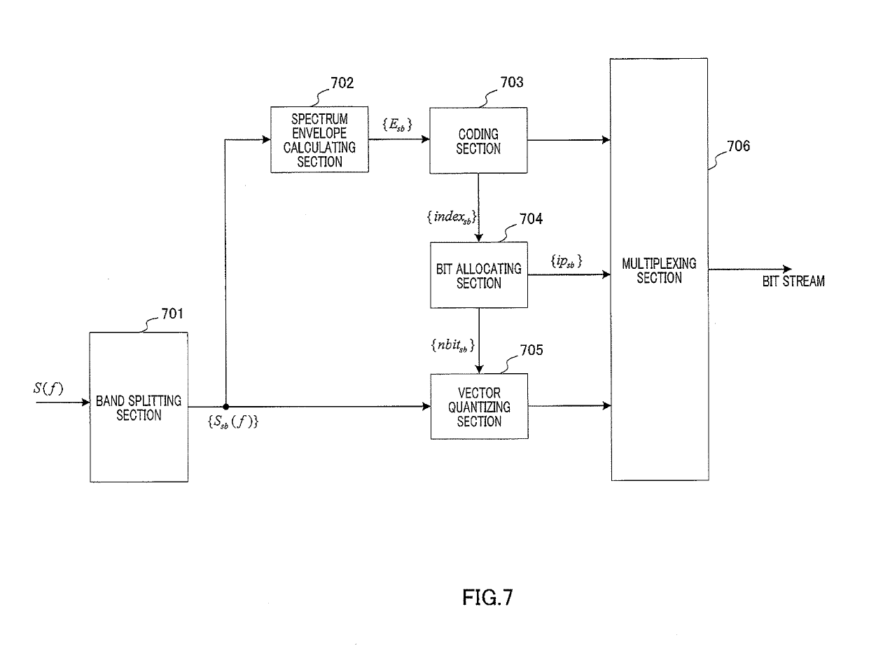

FIG. 8 illustrates a calculation example of perceptual importance level of the TDAC coding in G.729.1;

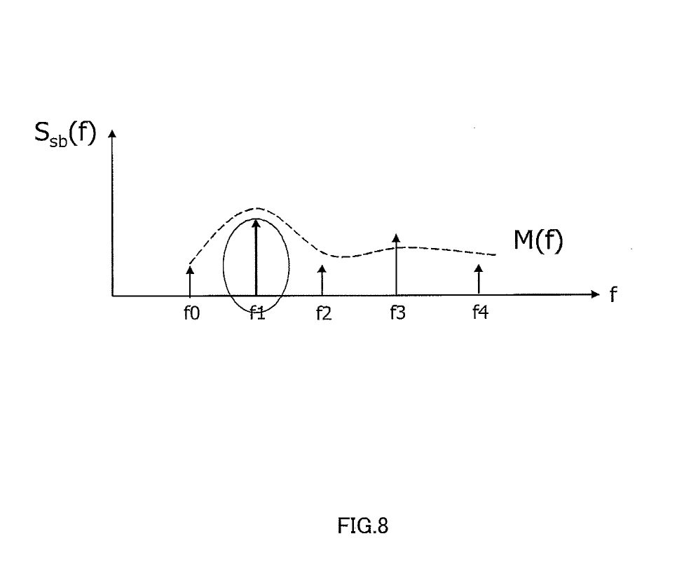

FIG. 9 illustrates a calculation example of perceptual importance level of the present invention;

FIG. 10A illustrates a configuration of a speech coding apparatus according to embodiment 1 of the present invention;

FIG. 10B illustrates a speech decoding apparatus according to embodiment 1 of the present invention;

FIG. 11 illustrates a configuration of a perceptually-weighting section according to embodiment 1 of the present invention;

FIG. 12 illustrates a state where each spectral coefficient is perceptually weighted in embodiment 1 of the present invention;

FIG. 13A illustrates a configuration of a speech coding apparatus according to embodiment 2 of the present invention;

FIG. 13B illustrates a speech decoding apparatus according to embodiment 2 of the present invention;

FIG. 14 illustrates a configuration of a perceptually-weighting section according to embodiment 2 of the present invention;

FIG. 15 illustrates a state where each spectral coefficient is perceptually weighted in embodiment 2 of the present invention;

FIG. 16A illustrates a configuration of a speech coding apparatus according to embodiment 3 of the present invention;

FIG. 16B illustrates a speech decoding apparatus according to embodiment 3 of the present invention;

FIG. 17 illustrates a configuration of a perceptually-weighting section according to embodiment 3 of the present invention (configuration example 1);

FIG. 18 illustrates a configuration of a perceptually-weighting section according to embodiment 3 of the present invention (configuration example 2); and

FIG. 19 illustrates a state where each spectral coefficient is perceptually weighted in embodiment 3 of the present invention.

### DESCRIPTION OF EMBODIMENT

The present invention calculates the perceptual importance level, not on a subband basis but on each spectral coefficient basis in encoding spectral coefficients. The present invention calculates respective weighting coefficients for applying the weighting coefficients to the spectral coefficients, according to a psychoacoustic model analysis, a signal-to-noise ratio, or the resulting perceptual importance levels based on a parameter related to a perceptual system. The weighting coefficient is larger as the perceptual importance level of a spectral coefficient is higher, and the weighting coefficient is smaller as the perceptual importance level is lower. Thus, it is possible to obtain perceptually good sound quality by encoding a perceptually-weighted spectral coefficient.

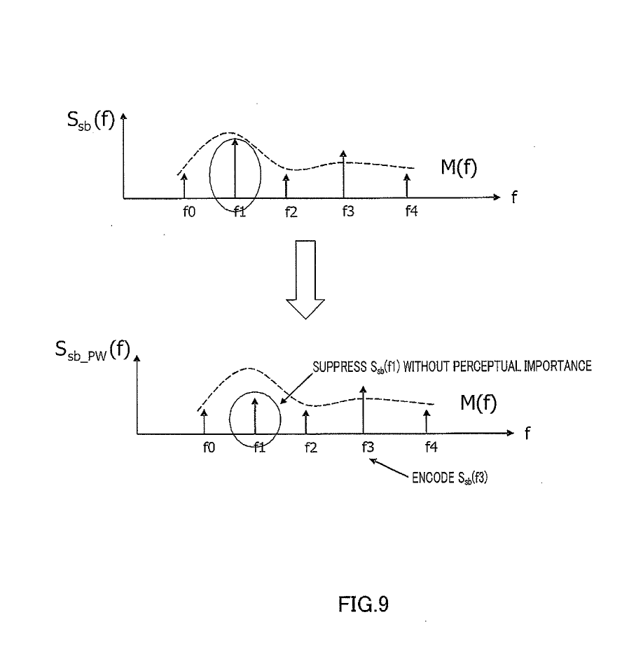

The present invention determines the perceptual importance level according to a masking curve as illustrated in FIG. 9. The perceptual importance level shows that S_{sb}(f1) has the largest amplitude but is not perceptually important. For this reason, assignment of a low weight to S_{sb}(f1) with low perceptual importance level suppresses S_{sb}(f1). As a result, the most perceptually-important S_{sb}(f3) will be encoded.

A first aspect of the present invention determines respective perceptual importance levels of spectral coefficients, then determines weighting coefficients according to the perceptual importance levels, applies the weighting coefficients to the spectral coefficients, respectively, and encodes the perceptually-weighted spectral coefficients.

By this means, the perceptually-weighting coefficients are more accurate because the coefficients are calculated respectively for the spectral coefficients. It is therefore possible to select and encode the most perceptually-important spectral coefficient, and thereby to obtain better coding performance (improvement in sound quality).

In a second aspect of the present invention, only the coding side applies the perceptually-weighting coefficients. That is, the decoding side does not perform inverse weighting processing corresponding to the application at the coding side.

By this means, there is no need to transmit the perceptually-weighting coefficients to the decoding side. Thus, it is possible to save bits in encoding the perceptually-weighting coefficients.

In a third aspect of the present invention, layer coding (scalable coding) updates the perceptual importance level of an error signal in each layer. In each layer, the layer coding calculates the weight according to the perceptual importance level and applied to each coding-target spectral coefficient.

By this means, in each coding step or layer, a signal is encoded according to the perceptual importance level, and therefore it is possible to obtain better coding performance (improvement in sound quality) in each coding step or layer.

Embodiments of the present invention will now be explained with reference to the accompanying drawings.

### Embodiment 1

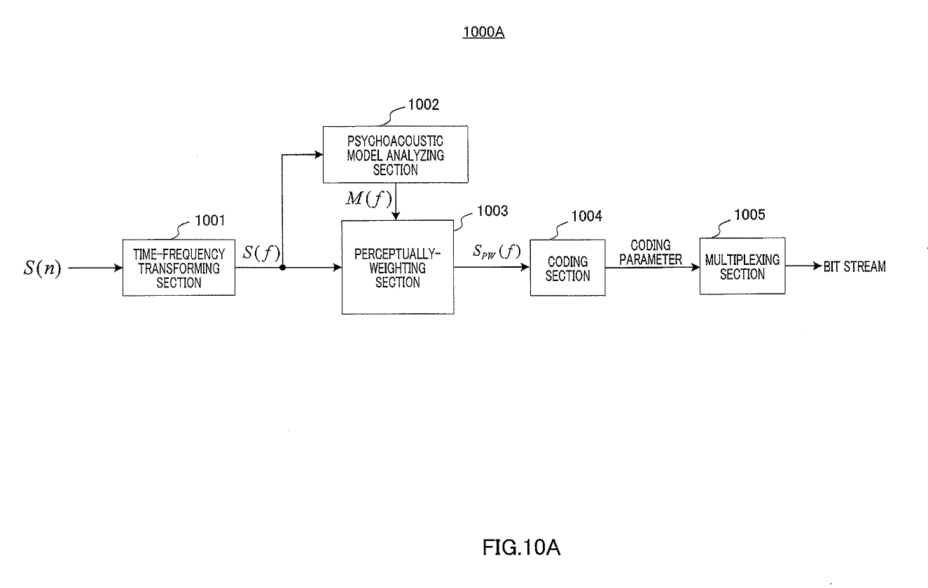

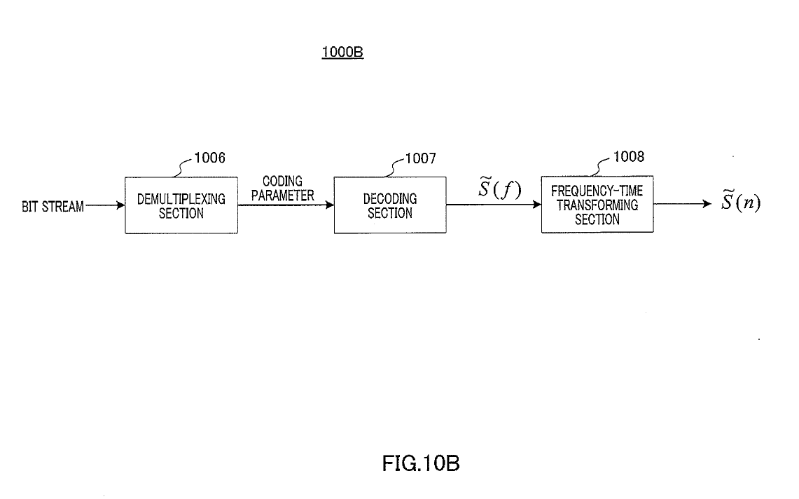

FIG. 10A illustrates a configuration of speech coding apparatus 1000A according to the present embodiment. FIG. 10B illustrates a configuration of speech decoding apparatus 1000B according to the present embodiment.

In the present embodiment, a pulse vector coding perceptually weights each spectral coefficient.

In speech coding apparatus 1000A (FIG. 10A), time-frequency transforming section 1001 transforms time domain signal S(n) into frequency domain signal S(f) (spectral coefficients), using time-frequency transformation such as discrete Fourier transform (DFT) or modified discrete cosine transform (MDCT).

Psychoacoustic model analyzing section 1002 determines a masking curve by performing a psychoacoustic model analysis on frequency domain signal S(f).

Perceptually-weighting section 1003 estimates perceptual importance levels based on the masking curve, and calculates respective weighting coefficients for the spectral coefficients according to the perceptual importance levels, to apply the weighting coefficients to the spectral coefficients, respectively.

Coding section 1004 encodes perceptually-weighted frequency domain signal S_{PW}(f) to generate a coding parameter.

Multiplexing section 1005 multiplexes the coding parameter with the signal to generate bit stream information and transmits the bit stream information to speech decoding apparatus 1000E (FIG. 10B).

In speech decoding apparatus 1000B (FIG. 10B), demultiplexing section 1006 demultiplexes the bit stream information to generate the coding parameter.

Decoding section 1007 decodes the coding parameter to generate decoded frequency domain signal S^{˜}(f).

Frequency-time transforming section 1008 transforms decoded frequency domain signal S^{˜}(f) into a time domain using frequency-time transformation such as inverse discrete Fourier transform (IDFT) or inverse modified discrete cosine transform (IMDCT), to generate decoded time domain signal S^{˜}(n).

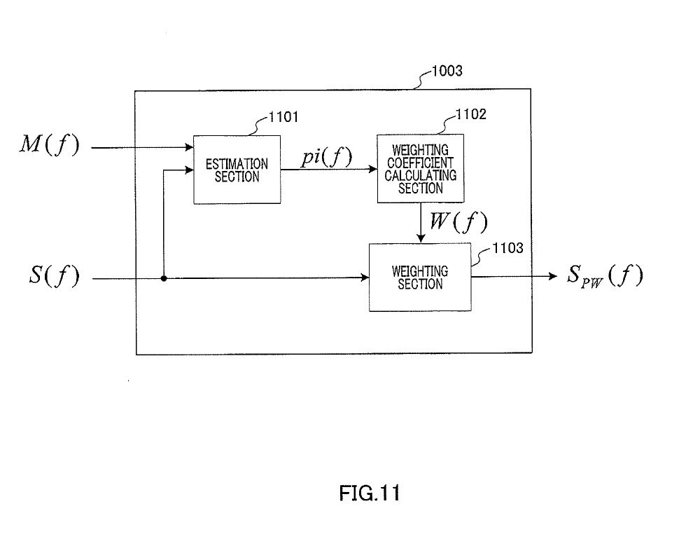

FIG. 11 illustrates a configuration of perceptually-weighting section 1003 according to the present embodiment. FIG. 11 illustrates a configuration to perceptually weight each spectral coefficient.

In perceptually-weighting section 1003, estimation section 1101 estimates perceptual importance level pi(f) of each spectral coefficient, according to masking curve M(f). Perceptual importance level pi(f) is the parameter quantitatively representing how perceptually important the spectral coefficient is. Perceptual importance level pi(f) showing a larger value means that the spectral coefficient corresponding to the pi(f) is perceptually important. Perceptual importance level pi(f) is calculated based on masking curve M(f) and an energy level of a spectral coefficient. The calculation may be performed in a logarithmic region, and, for example, perceptual importance level pi(f) is calculated according to the following equation.

[1]

pi(f)=log(S²(f))−log(M(f)) (Equation 1)

Weighting coefficient calculating section 1102 calculates weighting coefficient W(f) based on perceptual importance level pi(f). Weighting coefficient W(f) is used for applying a weight to spectral coefficient S(f). As perceptual importance level pi(f) shows a larger value, weighting coefficient W(f) becomes a larger value. For example, weighting coefficient W(f) is calculated as the following equation.

[2]

W(f)=e^{pi(f)} (Equation 2)

Weighting section 1103 multiplies spectral coefficient S(f) by weighting coefficient W(f) to generate perceptually-weighted spectral coefficient S_{PW}(f). Thus, spectral coefficient S_{PW}(f) is calculated as the following equation.

[3]

S_{PW}(f)=W(f)*S(f) (Equation 3)

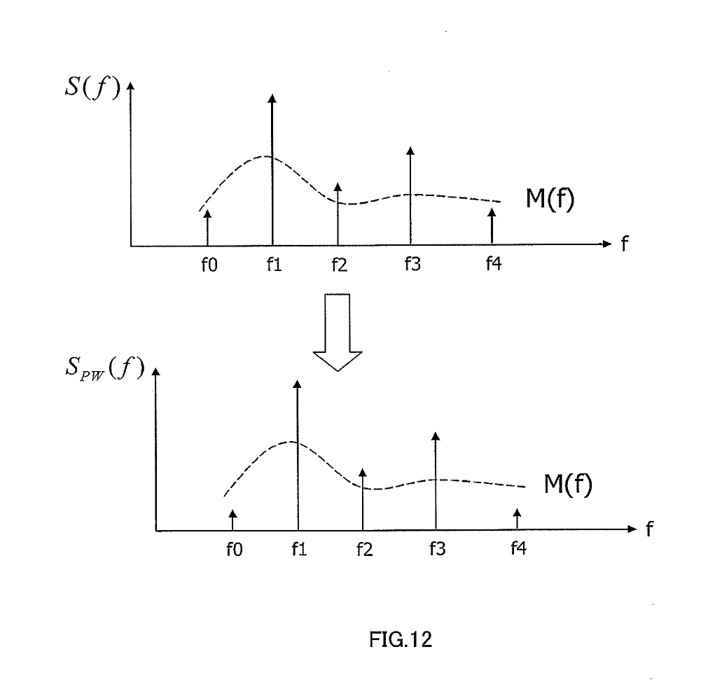

FIG. 12 illustrates a state where each spectral coefficient is perceptually weighted.

As illustrated in FIG. 12, energy levels of spectral coefficient S(f0) and S(f4) are lower than points of masking curve M(f0) and M(f1), respectively. At this time, weighting coefficients W(f0) and W(f4) multiplied to these two spectral coefficients respectively are less than 1, and hence the energy levels of spectral coefficients S(f0) and S(f4) are suppressed.

As an example, when perceptual importance level pi(f) and weighting coefficient W(f) are calculated as the above, perceptually-weighted spectral coefficients S_{PW}(f0) and S_{PW}(f4) are represented as the following, and reveal that those coefficients S_{PW}(f0) and S_{PW}(f4) become lower than spectral coefficients S(f0) and S(f4) respectively.

[4]

pi(f0)=log(S²(f0))−log(M(f0))<0;

pi(f4)=log(S²(f4))−log(M(f4))<0;

then

W(f0)=e^{pi(f0}<1;

W(f4)=e^{pi(f4)}<1;

then

S_{PW}(f0)=W(f0)*S(f0)<S(f0);

S_{PW}(f4)=W(f4)*S(f4)<S(f4); (Equation 4)

According to the present embodiment, a pulse vector coding determines the perceptual importance levels of the spectral coefficients, determines weighting coefficients according to the perceptual importance levels, applies the weighting coefficients to the respective spectral coefficients, and encodes the perceptually-weighted spectral coefficients.

By this means, the perceptually-weighting coefficients can calculate each spectral coefficient more accurately, in comparison with performing perceptual-weighting processing on a subband basis. Thus, it is possible to select and encode the most perceptually-important spectral coefficients and hence to obtain better coding performance.

According to the present embodiment, only the coding side (speech coding apparatus 1000A) applies perceptually-weighting coefficients. That is, the decoding side (speech decoding apparatus 1000B) does not perform inverse weighting processing with respect to the above processing.

By this means, there is no need to transmit perceptually-weighting coefficients to the decoding side. Thus, it is possible to save bits in encoding the perceptually-weighting coefficients.

### Embodiment 2

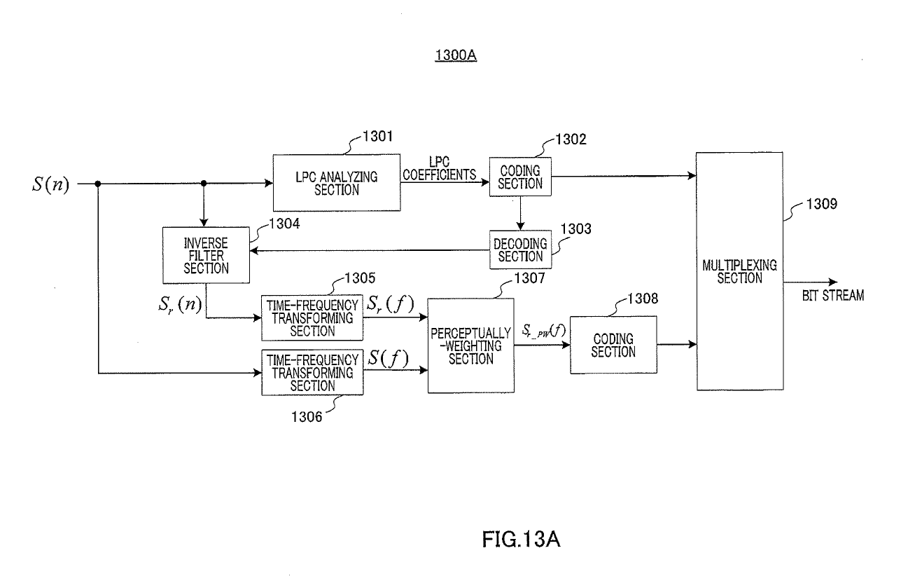

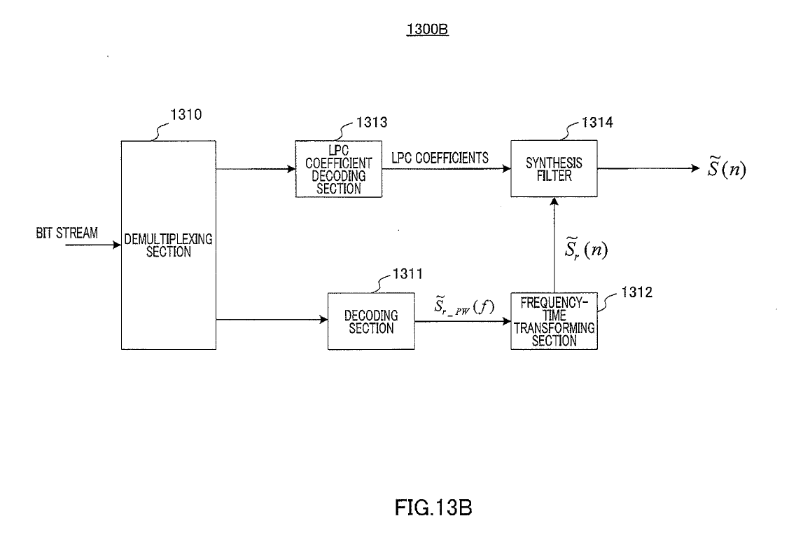

FIG. 13A illustrates a configuration of speech coding apparatus 1300A according to the present embodiment. FIG. 13B also illustrates a configuration of speech decoding apparatus 1300B according to the present embodiment.

In the present embodiment, a TCX coding perceptually weights each spectral coefficient.

In speech coding apparatus 1300A (FIG. 13A), LPC analyzing section 1301 performs LPC analysis on an input signal, so as to use redundancy of a signal in a time domain.

Coding section 1302 encodes the LPC coefficients from LPC analyzing section 1301.

Decoding section 1303 decodes the encoded LPC coefficients.

Inverse filter section 1304 obtains residual (excitation) signal Sᵣ(n) by applying an LPC inverse filter to input signal S(n) using the decoded LPC coefficients from decoding section 1303.

Time-frequency transforming section 1305 transforms residual signal Sᵣ(n) into frequency domain signal Sᵣ(f) (spectral coefficients) using time-frequency transformation such as discrete Fourier transform (DFT) or modified discrete cosine transform (MDCT).

Time-frequency transforming section 1306 transforms original signal S(n) into frequency domain signal S(f) (spectral coefficients) using time-frequency transformation such as discrete Fourier transform (DFT) or modified discrete cosine transform (MDCT).

Perceptually-weighting section 1307 performing a psychoacoustic model analysis on frequency domain signal S(f), to calculate a masking curve. Perceptually-weighting section 1307 estimates the perceptual importance level based on the masking curve, calculates respective weighting coefficients of the spectral coefficients, and then applies the respective weighting coefficients to the spectral coefficients.

Coding section 1308 encodes perceptually-weighted residual signal Sᵣ_{_{—}}_{PW}(f) to generate a coding parameter.

Multiplexing section 1309 multiplexes the coding parameter with the signal to generated bit stream information, and transmits the bit stream information to the decoding side.

In speech decoding apparatus 1300B (FIG. 13B), demultiplexing section 1310 demultiplexes the bit stream information to generate the coding parameter and LPC coefficients.

Decoding section 1311 decodes the coding parameter to generate decoded residual signal Sᵣ^{˜}_{_{—}}_{PW}(f) of a frequency domain.

LPC coefficient decoding section 1313 decodes the LPC coefficients.

Frequency-time transforming section 1312 transforms decoded residual signal Sᵣ^{˜}_{_{—}}_{PW}(f) of a frequency domain into a time domain using frequency-time transformation such as inverse discrete Fourier transform (IDFT) or inverse modified discrete cosine transform (IMDCT), to generate decoded residual signal Sᵣ^{˜}(n) of a time domain.

Synthesis filter 1314 performs LPC synthesis filtering processing on decoded residual signal Sᵣ^{˜}(n) of a time domain using the decoded LPC coefficients from LPC coefficient decoding section 1313, to obtain decoded time domain signal S^{˜}(n).

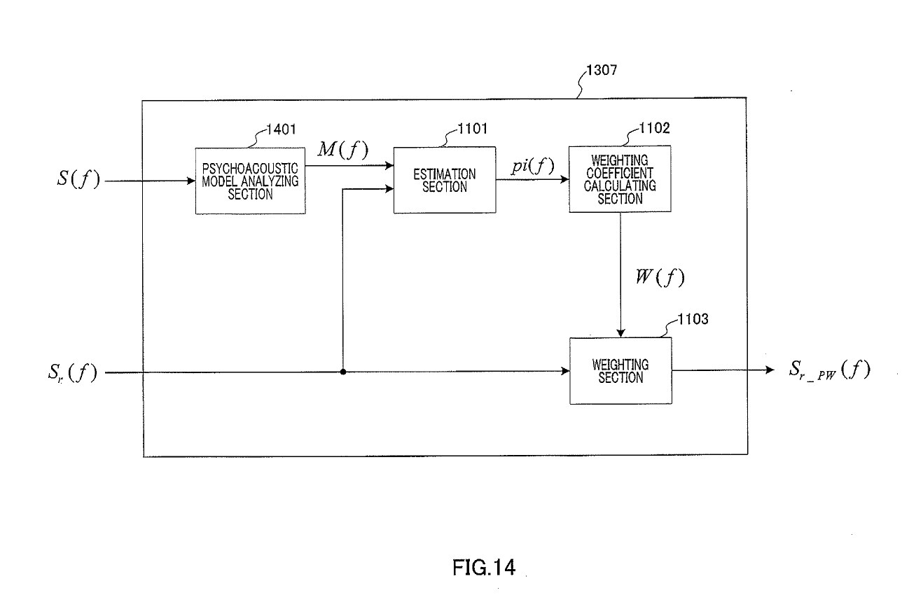

FIG. 14 illustrates a configuration of perceptually-weighting section 1307 according to the present embodiment. FIG. 14 illustrates a configuration to perceptually weight each spectral coefficient. Here, in FIG. 14, the same components as in FIG. 11 will be assigned the same reference numerals and detail explanations thereof will be omitted.

In perceptually-weighting section 1307, psychoacoustic model analyzing section 1401 calculates masking curve M(f) based on spectral coefficient S(f) of an original signal.

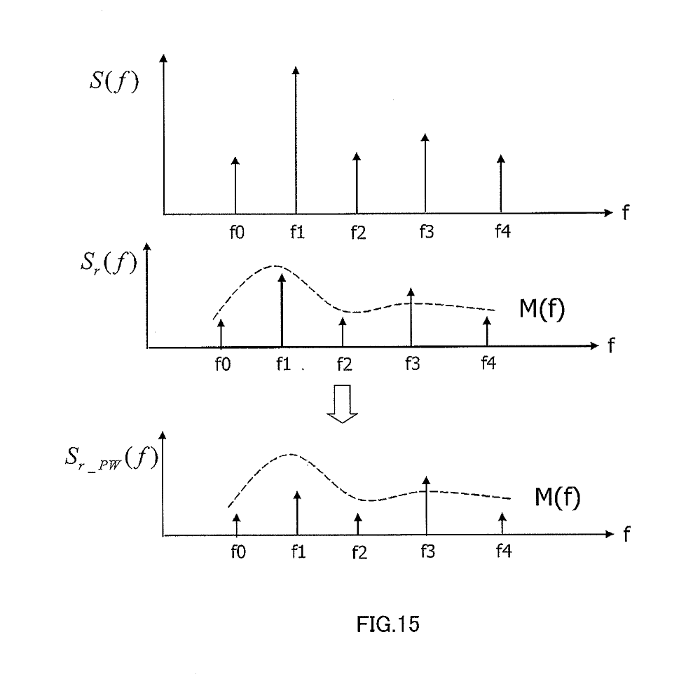

FIG. 15 illustrates a state to perceptually weight each spectral coefficient.

As illustrated in FIG. 15, energy levels of spectral coefficients S(f0), S(f1), S(f2), and S(f4) are lower than points of masking curve M(f0), M(f1), M(f2), and M(f4), respectively. Thus, the energy levels of these spectral coefficients are suppressed not to waste bits in encoding these spectral coefficients.

According to the present embodiment, TCX coding determines the perceptual importance levels of the respective spectral coefficients, determines weighting coefficients according to the perceptual importance levels, applies the respective weighting coefficients to the spectral coefficients, and encodes the perceptually-weighted spectral coefficients.

By this means, the perceptually-weighting coefficients can calculate each spectral coefficient more accurately, in comparison with performing perceptual-weighting processing on a subband basis. Thus, it is possible to select and encode the most perceptually-important spectral coefficient and hence to obtain better coding performance.

Accrding to the present embodiment, only the coding side (speech coding apparatus 1300A) applies perceptually-weighting coefficients. That is, the decoding side (speech decoding apparatus 1300B) does not perform inverse weighting processing with respect to the above processing.

By this means, there is no need to transmit perceptually-weighting coefficients to a decoding side. Thus, it is possible to save bits in encoding the perceptually-weighting coefficients.

### Embodiment 3

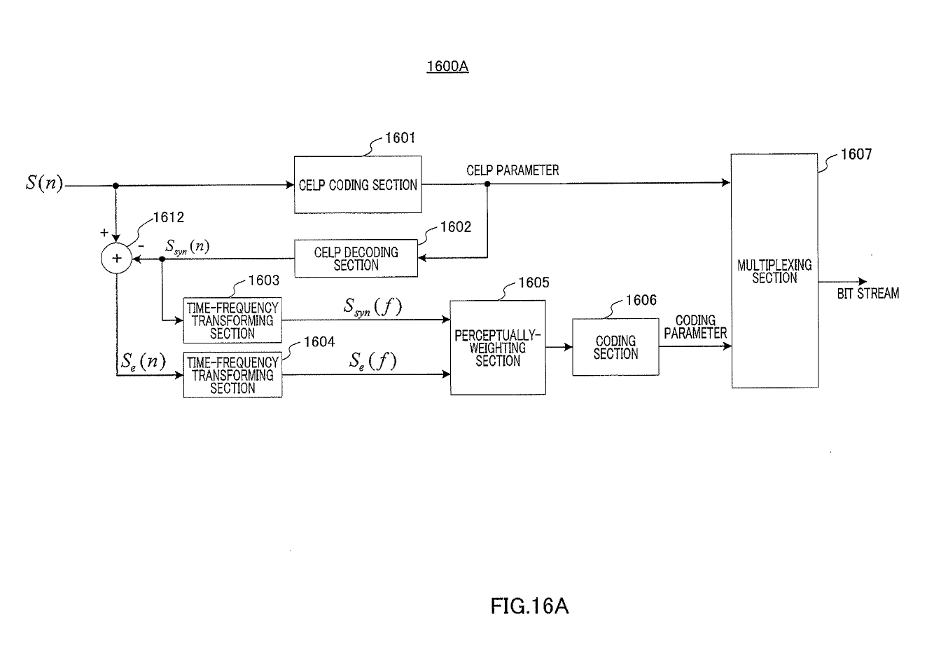

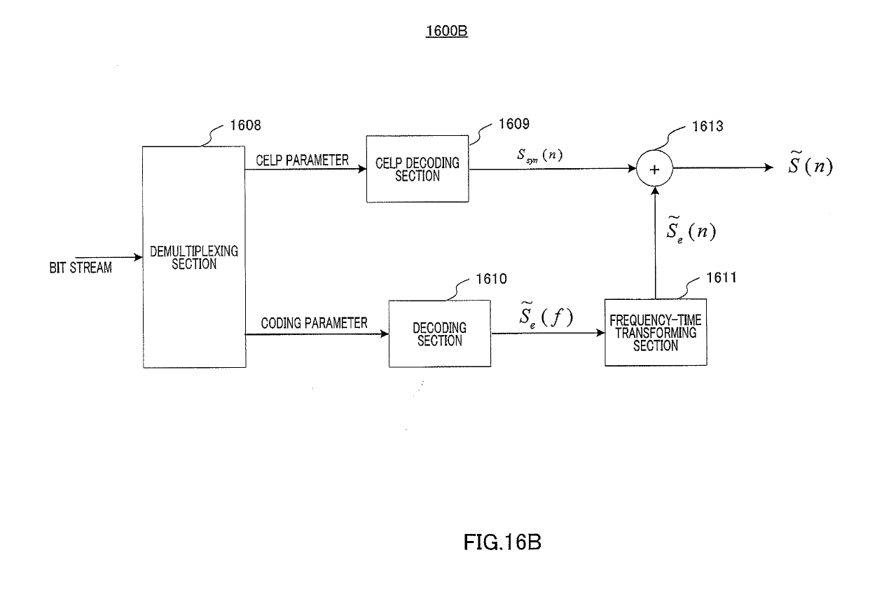

FIG. 16A illustrates a configuration of speech coding apparatus 1600A according to the present embodiment. FIG. 16B also illustrates a configuration of speech decoding apparatus 1600B according to the present embodiment.

In the present embodiment, layer coding (scalable coding), in which a lower layer adopts a CELP coding and a higher layer adopts a transform coding, perceptually weights each spectral coefficient. In the following explanation, although the layer coding including two layers of the lower layer and the higher layer will be explained as an example, it is possible to apply the present invention to the layer coding including three layers or more.

In speech coding apparatus 1600A (FIG. 16A), CELP coding section 1601 performs a CELP coding on an input signal so as to use redundancy of a signal in a time domain.

CELP decoding section 1602 generates synthesized signal S_{syn}(n) using the CELP parameter.

By subtracting the synthesized signal from the input signal, subtractor 1612 obtains error signal Sₑ(n) (error signal between the input signal and the synthesized signal).

Time-frequency transforming section 1604 transforms error signal Sₑ(n) into frequency domain signal Sₑ(f) (spectral coefficients) using time-frequency transformation such as discrete Fourier transform (DFT) or modified discrete cosine transform (MDCT).

Time-frequency transforming section 1603 transforms synthesized signal S_{syn}(n) from CELP decoding section 1602 into frequency domain signal S_{syn}(f) (spectral coefficients) using time-frequency transformation such as discrete Fourier transform (DFT) or modified discrete cosine transform (MDCT).

Perceptually-weighting section 1605 applies perceptual weighting of each spectral coefficient to spectral coefficient Sₑ(f). Here, perceptually-weighting coefficients are calculated based on spectral coefficient Sₑ(f) of an error signal and spectral coefficient S_{syn}(f).

Coding section 1606 encodes the perceptually-weighted signal to generate a coding parameter.

Multiplexing section 1607 multiplexes the coding parameter and the CELP parameter to generate bit stream information and transmits the bit stream information to the decoding side.

In speech decoding apparatus 1600B (FIG. 16B), demultiplexing section 1608 demultiplexes the bit stream information to generate the coding parameter.

Decoding section 1610 decodes the coding parameter to generate decoded error signal Sₑ^{˜}(f) of a frequency domain.

CELP decoding section 1609 generates synthesized signal S_{syn}(n) using the CELP parameter.

Frequency-time transforming section 1611 transforms decoded residual signal Sₑ^{˜}(f) of a frequency domain into a time domain using frequency-time transformation such as inverse discrete Fourier transform (IDFT) or inverse modified discrete cosine transform (IMDCT), to generate decoded error signal Sₑ^{˜}(n) of a time domain.

By adding CELP synthesized signal S_{syn}(n) and decoded error signal Sₑ^{˜}(n), adder 1613 generates decoded time domain signal S^{˜}(n).

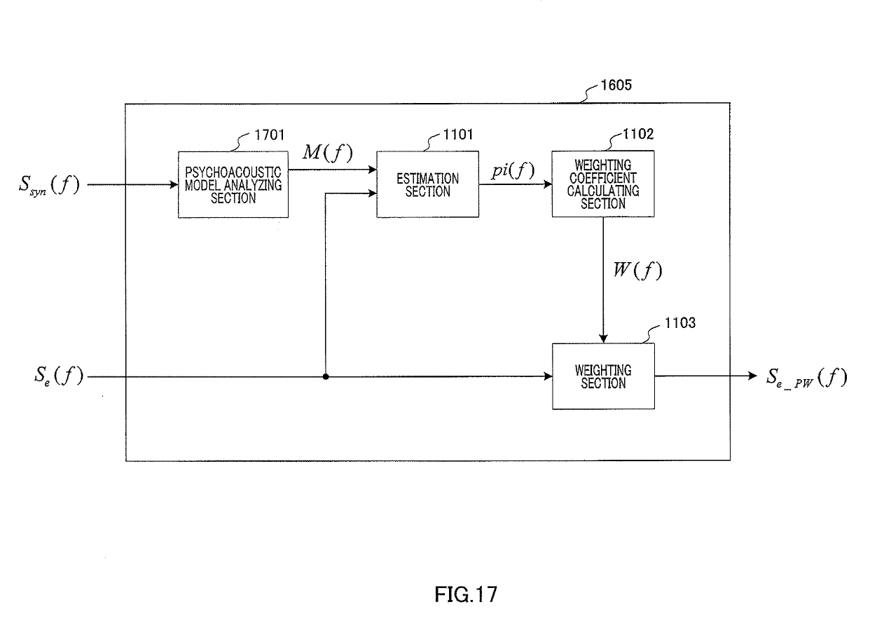

FIG. 17 illustrates a configuration of perceptually-weighting section 1605 according to the present embodiment (configuration example 1). FIG. 17 illustrates a configuration to perceptually weight each spectral coefficient. Here, in FIG. 17, the same components as in FIG. 11 will be assigned the same reference numerals and detail explanations thereof will be omitted.

In perceptually-weighting section 1605 (configuration example 1) illustrated in FIG. 17, psychoacoustic model analyzing section 1701 calculates masking curve M(f), based on spectral coefficient S_{syn}(f) of the CELP decoded signal.

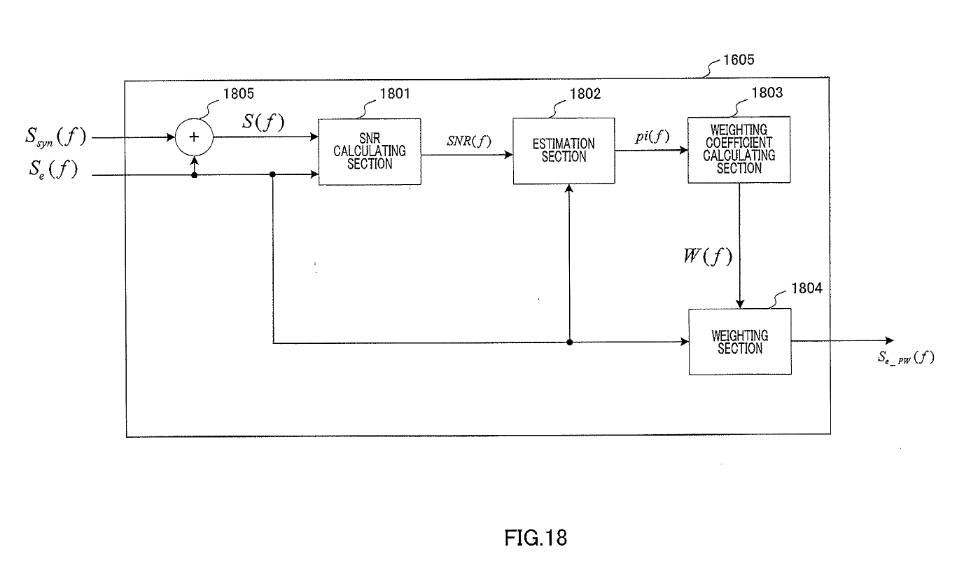

FIG. 18 illustrates a configuration of perceptually-weighting section 1605 according to the present embodiment (configuration example 2). FIG. 18 illustrates a configuration to perceptually weight each spectral coefficient.

In perceptually-weighting section 1605 (configuration example 2) illustrated in FIG. 18, adder spectrum S(f) of the original signal, by adding spectrum S_{syn}(f) of a CELP decoded signal and spectrum Sₑ(f) of an error signal.

SNR calculating section 1801 calculates a signal-to-noise ratio of generated spectrum S(f) of the original signal to spectrum Sₑ(f) of the error signal. Signal-to-noise ratio SNR(f) is calculated as the following equation.

$$\begin{matrix}( Equation 5 ) & \\ SNR ( f ) = \frac{{S}^{2} ( f )}{{S}_{e}^{2} ( f )} & [ 5 ]\end{matrix}$$

Estimation section 1802 estimates perceptual importance level pi(f) of each spectral coefficient, based on signal-to-noise ratio SNR(f). Perceptual importance level pi(f) is the parameter quantitatively representing how perceptually important the spectral coefficients are. Perceptual importance level pi(f) showing a larger value means that the spectral coefficients corresponding to the pi(f) are perceptually important. Perceptual importance pi(f) is calculated based on signal-to-noise ratio SNR(f) and energy of the spectral coefficients.

The calculation may be perform in a logarithmic region, and, for example, perceptual importance level pi(f) is calculated according to the following equation.

pi(f)=log(Sₑ²(f))−log(Sₐᵥₑ²)+log(SNRₐᵥᵣ)−log(SNR(f)) (Equation 6)

Here, Sₐᵥₑ² represents the average energy of spectral coefficients included a subband, and is calculated as the following equation.

$$\begin{matrix}( Equation 7 ) & \\ {S}_{ave}^{2} = \frac{{\sum }_{i = 0}^{N - 1} {S}_{e}^{2} ( i )}{N} & [ 7 ]\end{matrix}$$

Also, SNRₐᵥₑ represents the signal-to-noise ratio of the entire spectral coefficients included the subband, and is calculated as the following equation.

$$\begin{matrix}( Equation 8 ) & \\ {SNR}_{ave} = \frac{{\sum }_{i = 0}^{N - 1} {S}^{2} ( i )}{{\sum }_{i = 0}^{N - 1} {S}_{e}^{2} ( i )} & [ 8 ]\end{matrix}$$

Perceptual importance level pi(f) may be calculated as the following equation using terms of a signal-to-noise ratio.

[9]

pi(f)=log(SNRₐᵥₑ)−log(SNR(f)) (Equation 9)

Weighting coefficient calculating section 1803 calculates weighting coefficient W(f), based on perceptual importance level pi(f). Weighting coefficient W(f) is used for applying a weight to spectral coefficient S(f). As perceptual importance level pi(f) shows a larger value, weighting coefficient W(f) becomes a larger value. For example, weighting coefficient W(f) is calculated as the following equation.

[10]

W(f)=e^{pi(f)} (Equation 10)

Weighting section 1804 multiplies spectral coefficient S(f) by weighting coefficient W(f) to generate perceptually-weighted spectral coefficient Sₑ_{_{—}}_{pw}(f). Thus, spectral coefficient Sₑ_{_{—}}_{PW}(f) is calculated as the following equation.

[11]

Sₑ_{_{—}}_{PW}(f)=W(f)*Sₑ(f) (Equation 11)

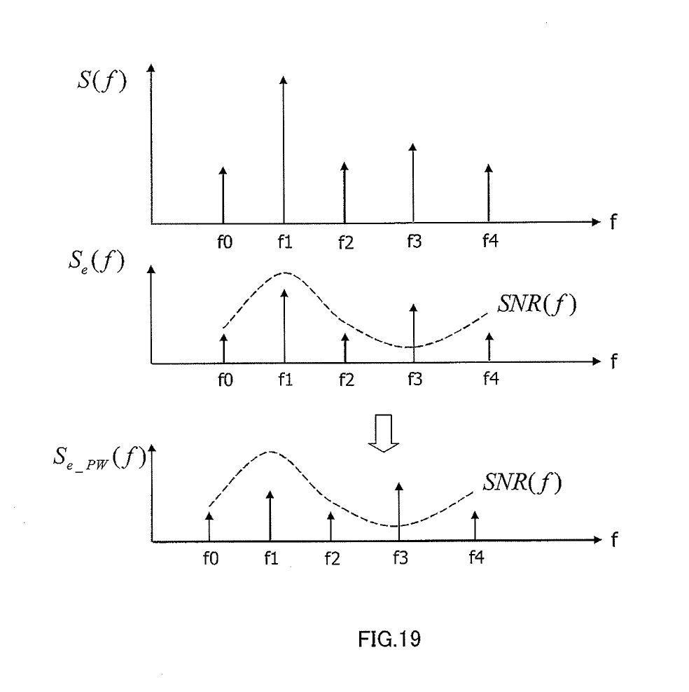

FIG. 19 illustrates a state where each spectral coefficient is perceptually weighted.

Focusing on spectral coefficient S(f1) in FIG. 19 shows that this spectral coefficient has a larger amplitude value than other spectral coefficients. Also, signal-to-noise ratio SNR(f1) at frequency f1 is a maximum value in comparison with other signal-to-noise ratios. At this time, the present embodiment multiplies a small weighting coefficient W(f1) which is less than 1 to spectral coefficient Sₑ(f1) of an error signal, and hence the amplitude value of weighted spectral coefficient Sₑ_{_{—}}_{PW}(f1) becomes smaller than that of Sₑ(f1).

As an example, when perceptual importance level pi(f) and weighting coefficient W(f) are calculated as the above, perceptually-weighted spectral coefficient Sₑ_{_{—}}_{PW}(f1) is represented as the following equation, to reveal that Sₑ_{_{—}}_{PW}(f1) becomes lower than spectral coefficient Sₑ(f1).

[12]

pi(f1)=log(SNRₐᵥₑ)−log(SNR(f1))<0;

then

W(f1)=e^{pi(f1)}<1;

then

Sₑ_{_{—}}_{PW}(f1)=W(f1)*Sₑ(f1)<S ₑ(f1); (Equation 12)

As described above, by calculating weighting coefficients on a frequency basis according to the signal-to-noise ratio, the present embodiment lowers the importance of the spectrum with a high signal-to-noise ratio to set coding bits less likely to be distributed to this spectrum.

As a result, distribution of more coding bits to other spectra with low signal-to-noise ratios improves the sound quality.

Embodiments of the present invention have been described above.

Although a case has been described with the above embodiments as an example where the present invention is implemented with hardware, the present invention can be implemented with software.

Each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

The method of implementing integrated circuitry is not limited to LSI, and implementation by means of dedicated circuitry or a general-purpose processor may also be used. After LSI manufacture, utilization of a programmable FPGA (Field Programmable Gate Array) or a reconfigurable processor where connections and settings of circuit cells within an LSI can be reconfigured is also possible.

In the event of the introduction of an integrated circuit implementation technology whereby LSI is replaced by a different technology as an advance in, or derivation from, semiconductor technology, integration of the function blocks may of course be performed using that technology. Application of biotechnology is also possible.

The disclosure of Japanese Patent Application No. 2010-006312, filed on Jan. 14, 2010, including the specification, drawings and abstract, is incorporated herein by reference in its entirety.

### INDUSTRIAL APPLICABILITY

The present invention is suitable for a communication apparatus encoding speech, a communication apparatus decoding speech, and especially a radio communication apparatus.

### Reference Signs List

1000A Speech coding apparatus
1000B Speech decoding apparatus
1001 Time-frequency transforming section
1002 Psychoacoustic model analyzing section
1003 Perceptually-weighting section
1004 Coding section
1005 Multiplexing section
1006 Demultiplexing section
1007 Decoding section
1008 Frequency-time transforming section
1101 Estimation section
1102 Weighting coefficient calculating section
1103 Weighting section
1300A Speech coding apparatus
1300B Speech decoding apparatus
1301 LPC analyzing section
1302 Coding section
1303 Decoding section
1304 Inverse filter section
1305 Time-frequency transforming section
1306 Time-frequency transforming section
1307 Perceptually-weighting section
1308 Coding section
1309 Multiplexing section
1310 Demultiplexing section
1311 Decoding section
1312 Frequency-time transforming section
1313 LPC coefficient decoding section
1314 Synthesis filter
1401 Psychoacoustic model analyzing section
1600A Speech coding apparatus
1600B Speech decoding apparatus
1601 CELP coding section
1602 CELP decoding section
1603 Time-frequency transforming section
1604 Time-frequency transforming section
1605 Perceptually-weighting section
1606 Coding section
1607 Multiplexing section
1608 Demultiplexing section
1609 CELP decoding section
1610 Decoding section
1611 Frequency-time transforming section
1612 Subtractor
1613 Adder
1701 Psychoacoustic model analyzing section
1801 SNR calculating section
1802 Estimation section
1803 Weighting coefficient calculating section
1804 Weighting section
1805 Adder

1. A speech coding apparatus comprising:
an estimation section that estimates respective perceptual importance levels of a plurality of spectral coefficients of different frequencies;
a calculating section that calculates respective weighting coefficients of the plurality of spectral coefficients based on the respective estimated importance levels;
a weighting section that weights each of the plurality of spectral coefficients using the respective calculated weighting coefficients; and
a coding section that encodes the plurality of weighted spectral coefficients.

2. The speech coding apparatus according to claim 1, wherein the estimation section estimates the importance level based on a perceptual masking curve determined from an input signal.

3. A speech coding apparatus that performs layer coding including at least two layers of a lower layer and a higher layer, the speech coding apparatus comprising:
a generating section that generates an error signal between a decoded signal of the lower layer and an input signal;
an estimation section that calculates a signal-to-noise ratio using the input signal and the error signal and estimates respective perceptual importance levels of a plurality of spectral coefficients of different frequencies in the error signal, based on the signal-to-noise ratio;
a calculating section that calculates respective weighting coefficients of the plurality of spectral coefficients based on the respective estimated importance levels;
a weighting section that weights each of the plurality of spectral coefficients using the respective calculated weighting coefficients; and
a coding section that encodes the plurality of weighted spectral coefficients.

4. A speech coding method comprising the steps of:
estimating respective perceptual importance levels of a plurality of spectral coefficients of different frequencies;
calculating respective weighting coefficients of the plurality of spectral coefficients based on the respective estimated perceptual importance levels;
weighting each of the plurality of spectral coefficients using the respective calculated weighting coefficients; and
encoding the plurality of weighted spectral coefficients.
